(19) United States
(12) Patent Application Publication
(10) Pub. No.: US 2008/0082859 A1
(43) Pub. Date: Apr. 3, 2008

(54) Storage apparatus and control apparatus thereof

(75) Inventor: Masayuki Kondo, Kawasaki (JP)

Correspondence Address: Patrick G. Burns;GREER, BURNS & CRAIN, LTD., Suite 2500, 300 South Wacker Dr., Chicago, IL, 60606, US

(73) Assignee: Fujitsu Limited, Kawasaki-shi (JP)

(21) Appl. No.: 11/788,296

(22) Filed: Apr. 18, 2007

(30) Foreign Application Priority Data
Sep. 28, 2006 (JP) 2006-264816

(51) Int. Cl. G06F 11/00

(52) U.S. Cl. 714/8

(57) ABSTRACT

There is provided a storage apparatus capable of relieving an error region and a control apparatus thereof.

A storage apparatus connectable to a host includes a host interface section 20 that notifies the host that data cannot be read out in the case where there is an error sector from which data cannot be read out by a read retry operation and acquires an instruction from the host; an MPU 12 that performs adjustment of a read parameter which is a parameter for data reading when the host interface section 20 acquires the error sector recovery instruction from the host; and a read channel 16 that uses a parameter that has been adjusted by the MPU 12 to read out data from the error sector.

### BACKGROUND OF THE INVENTION

1. Field of the Invention

The present invention relates to a storage apparatus that performs a read retry operation and a control apparatus thereof.

2. Description of the Related Art

In a magnetic disk drive used as an auxiliary storage apparatus of a computer, if read data has any error, error correction is performed by ECC (Error Correction Code) added to the data. If the error correction fails, an MPU (Micro Processing Unit) shifts to a read retry mode and perform a read a retry operation for an error sector in which the error correction has failed. In order to prevent the lowering of performance of the magnetic disk drive, the number of read retry operations is limited.

In a typical magnetic disk drive, read parameters to be set in a read channel for the read retry operation is previously prepared as a table, and the table is used to perform the read retry operation.

As a conventional art relating to the present invention, there is known a disk drive that repeats the read retry operation until the error amount becomes less than a predetermined amount or the number of the read retry operations reaches a predetermined number while changing parameters related to a read operation (refer to, e.g., Patent Document 1: Japanese Patent No. 3737293).

However, in the case where parameters for an assumed error sector and parameters for an actual error sector disagree with the each other, the read operation ends as unrecoverable error (retry-out), thus making it impossible to relieve (read) the error sector. Further, the number of the read retry operations is limited, so that it is difficult to apply a large number of parameters to the read retry operation.

### SUMMARY OF THE INVENTION

The present invention has been made to solve the above problems, and an object thereof is to provide a storage apparatus that relieves a defective region and a control apparatus of the storage apparatus.

To solve the above problem, according to a first aspect of the present invention, there is provided a storage apparatus connectable to an external device, comprising: an instruction acquisition section that notifies the external device that data cannot be read out in the case where there is an error sector from which data cannot be read out by a read retry operation and acquires an instruction from the external device; an adjustment section that performs adjustment of a read parameter which is a parameter for data reading when the instruction acquisition section acquires the error sector recovery instruction from the external device; and a read section that uses a parameter that has been adjusted by the adjustment section to read out data from the error sector.

The storage apparatus according to the present invention further comprises a reassignment section that performs reassignment of sectors between error and normal sectors in the case where the read section has succeeded in reading out data from the error sector.

In the storage apparatus according to the present invention, the reassignment section is further configured to write the data read out from the error sector in the reassigned sector.

In the storage apparatus according to the present invention, the adjustment section performs adjustment of the read parameter throughout a range larger than that of the value of the read parameter adjusted by the read retry operation.

In the storage apparatus according to the present invention, the adjustment section sets the read parameter in the read section while changing the read parameter to allow the read section to read out data from the error sector as well as uses a Quality Monitor function of the read section to measure a Quality Monitor value to adjust the read parameter so that the Quality Monitor value satisfies a predetermined Quality Monitor value condition.

In the storage apparatus according to the present invention, the predetermined Quality Monitor value condition is a condition in which the Quality Monitor value becomes minimum.

In the storage apparatus according to the present invention, the adjustment section allows the read section to read out data from the error sector at a plurality of times as well as uses an automatic following function of the read section to adjust the read parameter.

In the storage apparatus according to the present invention, the adjustment section acquires information concerning a combination of a plurality of previously set adjustment methods of read parameters and adjusts the read parameters according to the information.

In the storage apparatus according to the present invention, the information concerning a combination of a plurality of adjustment methods of read parameters differs from a value for adjusting the read parameter used in the read retry operation.

In the storage apparatus according to the present invention, the read parameter is at least one of an output gain adjustment value which is a value for adjusting the output gain of a waveform to be read out, a cut-off filter adjustment value which is a value for adjusting the cut-off filter for a waveform to be read out, a boost adjustment value which is a value for adjusting the boost for a waveform to be read out, and an FIR filter coefficient for a waveform to be read out.

In the storage apparatus according to the present invention, in the case where a waveform read out from the error sector satisfies a predetermined waveform condition, the adjustment section selects a predetermined read parameter and adjusts the selected read parameter.

In the storage apparatus according to the present invention, the predetermined waveform condition is a condition in which the output level of a waveform read out from the error sector becomes lower than a predetermined value, and the predetermined read parameter is the output gain adjustment value.

In the storage apparatus according to the present invention, the predetermined waveform condition is a condition in which a waveform read out from the error sector includes a distortion component or bit-crushing, and the predetermined read parameter is at least one of the cut-off filter adjustment value, boost adjustment value, and FIR filter coefficient.

According to a second aspect of the present invention, there is provided a control apparatus for controlling a storage apparatus connectable to an external device, comprising: an instruction acquisition section that notifies the external device that data cannot be read out in the case where there is an error sector from which data cannot be read out by a read retry operation and acquires an instruction from the external device; an adjustment section that performs adjustment of a read parameter which is a parameter for data reading when the instruction acquisition section acquires the error sector recovery instruction from the external device; and a read section that uses a parameter that has been adjusted by the adjustment section to read out data from the error sector.

The control apparatus according to the present invention further comprises a reassignment section that performs reassignment of sectors between error and normal sectors in the case where the read section has succeeded in reading out data from the error sector.

In the control apparatus according to the present invention, the reassignment section is further configured to write the data read out from the error sector in the reassigned sector.

In the control apparatus according to the present invention, the adjustment section performs adjustment of the read parameter throughout a range larger than that of the value of the read parameter adjusted by the read retry operation.

In the control apparatus according to the present invention, the adjustment section changes the read parameter to read out data from the error sector as well as uses a Quality Monitor function to measure a Quality Monitor value to adjust the read parameter so that the Quality Monitor value satisfies a predetermined Quality Monitor value condition.

In the control apparatus according to the present invention, the predetermined Quality Monitor value condition is a condition in which the Quality monitor value becomes minimum.

In the control apparatus according to the present invention, the adjustment section reads out data from the error sector at a plurality of times as well as uses an automatic following function to adjust the read parameter.

According to the present invention, it is possible to relieve a defective region on a medium. Therefore, data storage assurance can be increased, thereby realizing a storage apparatus with high data storage reliability and a control apparatus used for the data storage apparatus.

### BRIEF DESCRIPTION OF THE DRAWINGS

FIG. 1 is a block diagram showing an example of a structure of a magnetic disk drive according to a first embodiment;

FIG. 2 is a flowchart showing an example of operation of an unrecoverable error processing according to the first embodiment;

FIG. 3 is a flowchart showing an example of operation of a read parameter adjustment processing according to the first embodiment;

FIG. 4 is a waveform diagram showing an example of an envelope curve of a preamplifier output waveform;

FIG. 5 is a waveform diagram showing an example of a preamplifier output waveform;

FIG. 6 is a view schematically showing an example of output level adjustment processing according to the first embodiment;

FIG. 7 is a view schematically showing an example of output waveform adjustment processing according to the first embodiment;

FIG. 8 is a flowchart showing an example of operation of a read parameter adjustment processing according to a second embodiment;

FIG. 9 is a table showing an example of a rearrangement table according to the second embodiment; and

FIG. 10 is a flowchart showing an example of operation of a read parameter adjustment processing according to a third invention.

### DETAILED DESCRIPTION OF THE PREFERRED EMBODIMENTS

Embodiments of the present invention will be described below with reference to the accompanying drawings.

### First Embodiment

A configuration of a magnetic disk drive (storage apparatus) according to a first embodiment will be described.

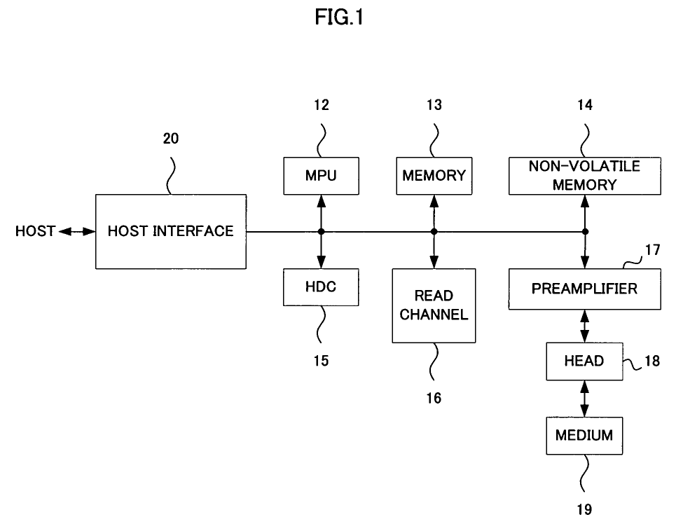

FIG. 1 is a block diagram showing an example of a structure of the magnetic disk drive according to the present embodiment. The magnetic disk drive includes an MPU 12, a memory 13, a non-volatile memory 14, an HDC (Hard Disk Controller) 15, a read channel 16, a preamplifier 17, a head 18, a medium 19, and a host interface 20.

The host interface 20 is connected to a host which is an external device. Data that has been read from the medium 19 at the reading time is sent, through the head 18 and preamplifier 17, to the read channel 16 where the data is decoded. The decoded data is then subjected to error correction by the HDC 15. The non-volatile memory 14 stores a firmware program and read parameters executed by the MPU 12. The MPU 12 uses the memory 13 to execute the firmware program and controls respective sections in the magnetic disk drive. Further, the MPU 12 reads out a read parameter from the non-volatile memory 14 and sets the read parameter in the read channel 16.

The read channel 16 has a Quality Monitor function and a function of automatically following the read parameter. The Quality Monitor function is a function of outputting a Quality Monitor value based on a read waveform. The lower the quality of the read waveform is, the higher the Quality Monitor value becomes. A VMM (Viterbi Metric Margin) may be used as the Quality Monitor value. The automatic following function is a function of performing a predetermined number of read operations to optimize a predetermined read parameter.

The read parameters stored in the non-volatile memory 14 include an output gain adjustment value which is a value for adjusting the output gain of the read waveform, a cut-off filter adjustment value which is a value for adjusting the cut-off filter for the read waveform, a boost parameter adjustment value which is a value for adjusting the boost for the read waveform, and an FIR (Finite Impulse Response) filter coefficient which is an FIR filter coefficient for the read waveform.

Unrecoverable error processing performed in the case where unrecoverable error occurs in the magnetic disk drive according to the present embodiment will next be described.

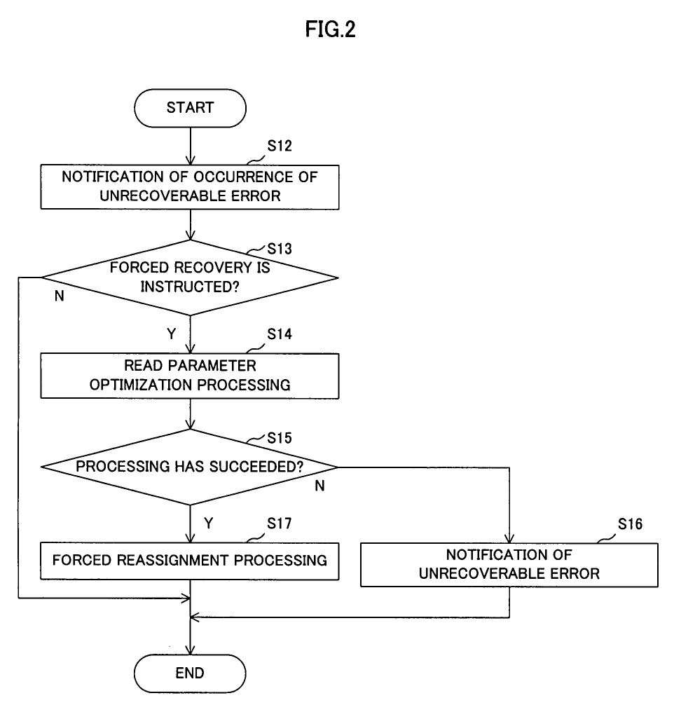

FIG. 2 is a flowchart showing an example of operation of the unrecoverable error processing according to the present embodiment. The MPU 12 notifies the host of occurrence of the unrecoverable error (S12) and, after that, determined whether it has received from the host an instruction to perform forced recovery processing (S13). When receiving the notification of the occurrence of unrecoverable error from the magnetic disk drive, the host sends an instruction of execution of the forced recovery processing to the magnetic disk drive using an OS (Operating System). Further, upon receiving the notification, the host may inquire of a user whether the forced recovery processing is performed. In this case, only when the user selects the forced recovery processing, the host sends the instruction to the magnetic disk drive. The forced recovery processing includes read parameter adjustment processing and forced reassignment processing for error sector.

In the case where the MPU 12 does not receive an instruction to perform the forced recovery processing (N in S13), this flow ends. On the other hand, when receiving the instruction (Y in S13), the MPU 12 performs read parameter adjustment processing to adjust a read parameter for reading an error sector (S14) and determines whether the read parameter adjustment processing has succeeded (S15). If the read parameter adjustment processing has failed (N in S15), the MPU 12 determines that the error sector cannot be corrected and notifies the host of the unrecoverable error once again (S16), and this flow ends. On the other hand, when the read parameter adjustment processing has succeeded (Y in S15), the MPU 12 performs forced reassignment processing between error sector and normal sector (S17), and this flow ends.

In the typical reassignment processing, data writing is performed once again for the error sector and, in the case where data can be read from the error sector, a replacement sector is not assigned; while in the case where data cannot be read from the error sector, a replacement sector is assigned. On the other hand, in the forced reassignment processing according to the present embodiment, data writing is not performed once again for the error sector but a replacement sector is forcibly assigned. Further, in the forced reassignment processing, data that can be read from the error sector by the read parameter adjustment processing may be written in the replacement sector.

The abovementioned read parameter adjustment processing will next be described.

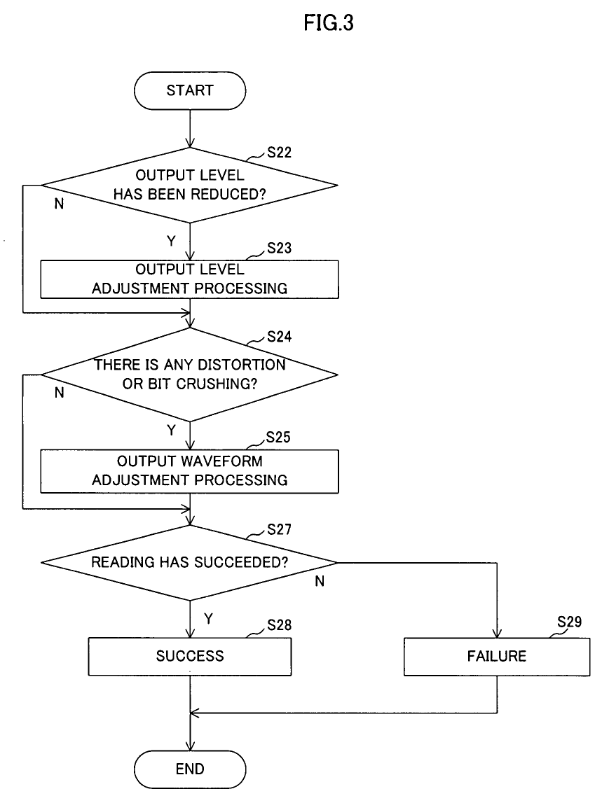

The read parameter adjustment processing according to the present embodiment determines the type of read parameter adjusted by a read waveform. FIG. 3 is a flowchart showing an example of operation of the read parameter adjustment processing according to the present embodiment. The MPU 12 determines whether the output level of the preamplifier 17 at the error sector reading time is reduced to less than a predetermined value. In the case where the output level is not reduced to less than a predetermined value (N in S22), the flow advances to the next step. In the case where the output level is reduced to less than a predetermined value (Y in S22), the MPU 12 performs output level adjustment processing so as to adjust an output gain adjustment value (S23), and the flow advances to the next step.

Then, the MPU 12 determines whether there is any distortion or bit-crushing in the output waveform of the preamplifier 17 at the error sector reading time. In the case where there is no distortion or bit-crushing (N in S24), the flow advances to the next step. In the case where there is any distortion or bit crushing (Y in S24), the MPU 12 performs output waveform adjustment processing so as to adjust the cut-off filter adjustment value, boost adjustment value, and FIR filter coefficient (S25), and the flow advances to the next step.

Then, the MPU 12 sets the adjusted read parameter in the read channel 16 and performs read check for the error sector. In the case where the reading operation has succeeded (Y in S27), the MPU 12 determines the read check to be a success (S28), and the flow ends. In the case where the reading operation has failed (N in S27), the MPU 12 determines the read check to be a failure (S29), and this flow ends.

The details of the processing of step S22 will next be described.

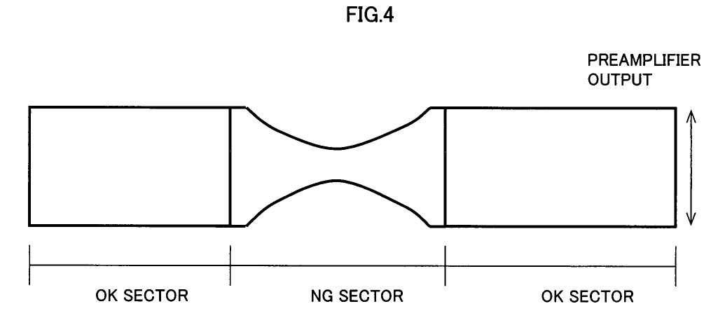

FIG. 4 is a waveform diagram showing an example of an envelope curve of the preamplifier output waveform. In this diagram, the horizontal axis denotes time and vertical axis denotes the output level of the preamplifier 17. As shown in FIG. 4, the output level from an error sector (NG sector) may extremely decrease due to scratch in some cases as compared to the output level from a normal sector (OK sector). In such a case, it is effective to adjust the output gain adjustment value among the read parameters.

The details of the processing of step S24 will next be described.

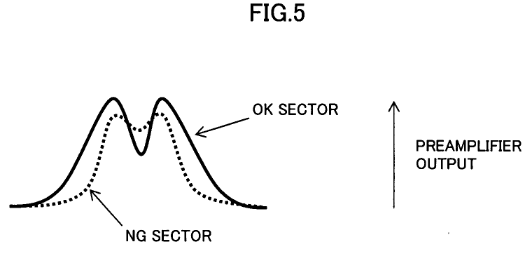

FIG. 5 is a waveform diagram showing an example of a preamplifier output waveform. In this diagram, the horizontal axis denotes time and vertical axis denotes the output level of the preamplifier 17. The solid line waveform denotes the output waveform from the OK sector and dotted line waveform denotes the output waveform from the NG sector. These waveforms are “111” pattern waveforms. As shown in FIG. 5, there may be a case where the bit crushing occurs, due to scratch, in the output waveform from the NG sector. In such a case, it is effective to adjust the cut-off filter adjustment value, boost adjustment value, and FIR filter coefficient among the read parameters. In the present embodiment, a Quality Monitor value is used in the output waveform adjustment processing.

The output level adjustment processing and output waveform adjustment processing will next be described in detail.

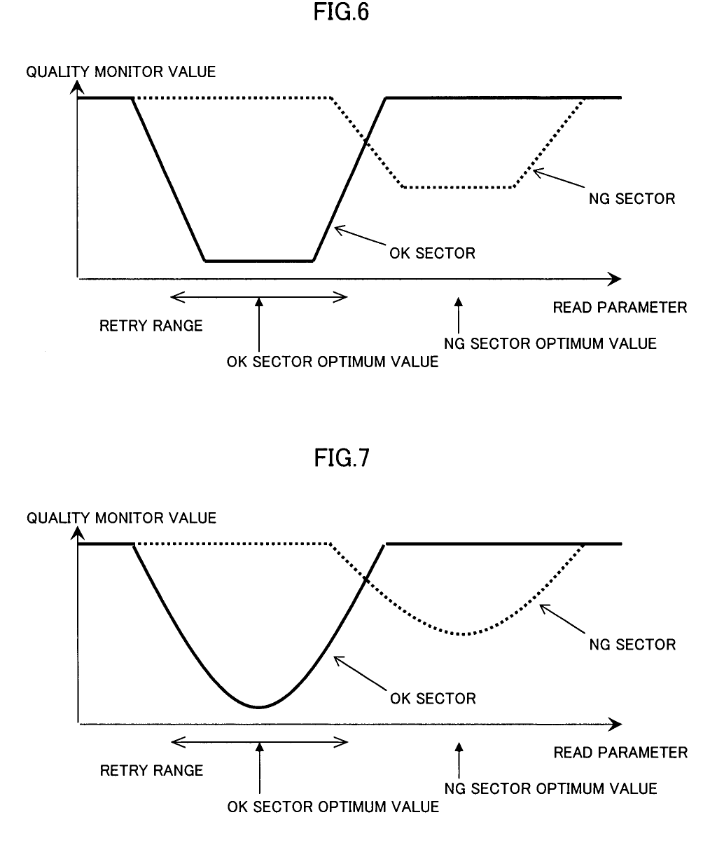

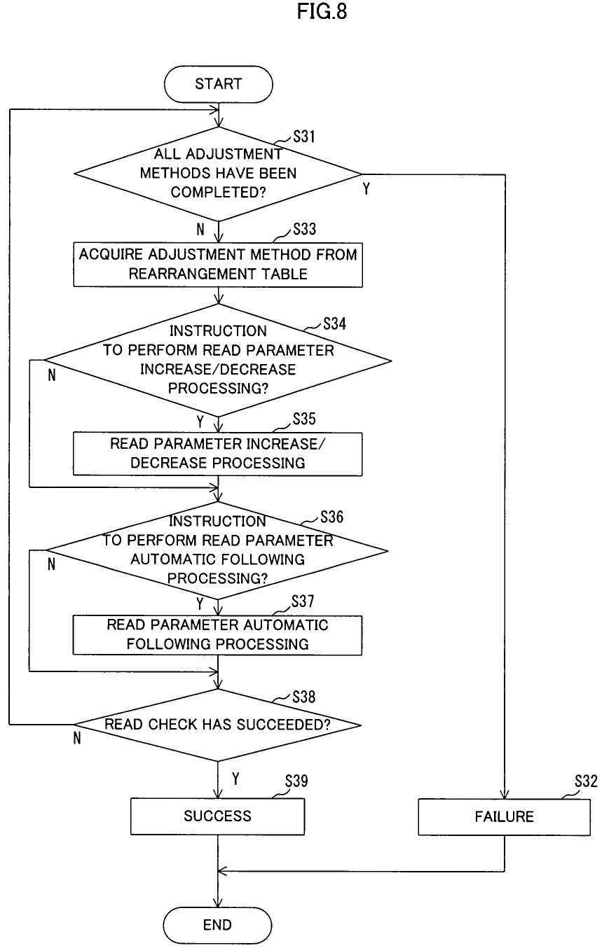

In the output level adjustment processing and output waveform adjustment processing according to the present embodiment, the Quality Monitor value is used as an index. FIG. 6 is a view schematically showing an example of the output level adjustment processing according to the present embodiment. In this diagram, the horizontal axis denotes a read parameter and vertical axis denotes a Quality Monitor value. The read parameter to be used in the output level adjustment processing is the output gain adjustment value. FIG. 7 is a view schematically showing an example of the output waveform adjustment processing according to the present embodiment. In this diagram, the horizontal axis denotes a read parameter and vertical axis denotes a Quality Monitor value. The read parameter to be used in the output wavelength adjustment processing is the cut-off filter adjustment value, boost adjustment value, or FIR filter coefficient.

In the two diagrams, the solid line represents a relationship between the read parameter and Quality Monitor value in the OK sector and the dotted line represents a relationship between the read parameter and Quality Monitor value in the NG sector. The retry range represents a range of the read parameter used for a normal read retry operation. As described above, based on the optimum value (OK sector optimum value) of the read parameter in the OK sector, the retry range is set in the vicinity of the OK sector optimum value, so that the OK sector optimum value does not reach the optimum value (NG sector optimum value) in the NG sector in some cases. Therefore, in the output level adjustment processing and output waveform adjustment processing, the Quality Monitor value is measured while the used read parameter is changed throughout the entire region, and the value of the read parameter (NG sector optimum value) at which the Quality Monitor value becomes minimum is determined.

Although the NG sector optimum value at which the Quality Monitor value becomes minimum is searched for from a relationship between one read parameter and Quality Monitor value in the above example of the output waveform adjustment processing, a combination of read parameter values at which the Quality Monitor value becomes minimum may be searched for from a relationship between a plurality of read parameters and Quality Monitor value.

The Quality Monitor value is used in the output level adjustment processing and output waveform adjustment processing. Alternatively, however, in the case where the magnetic disk drive has a function of automatically following the read parameter to be used, this function may be used to perform the output level adjustment processing and output waveform adjustment processing. In this case, the automatic following function reads the error sector at a plurality of times to optimize the read parameter.

According to the above embodiment, it is possible to take longer time for adjusting the read parameter in order to read the error sector as compared to the normal read retry operation. Further, by adjusting the read parameter in a wider range than in the case of the normal read retry operation, it is possible to set an effective read parameter even for the error sector in an unusual state. Therefore, the possibility that the data can normally be read from the error sector is increased to thereby increase the possibility that the data in the error sector can be relieved.

### Second Embodiment

A magnetic disk drive according to a second embodiment uses an adjustment method previously prepared in a form of a table to perform the read parameter adjustment processing.

The magnetic disk drive according to the present embodiment has the same configuration as that of the magnetic disk drive according to the first embodiment. Further, the unrecoverable error processing performed in the present embodiment is the same as that of the first embodiment.

The read parameter adjustment processing according to the present embodiment will next be described.

In the read parameter adjustment processing according to the present embodiment, in addition to a conventional table that defines an increase/decrease amount in each read parameter for the read retry operation, a default table that defines the default value for each read parameter and a rearrangement table that defines a read parameter adjustment method for the read parameter adjustment processing are prepared and stored in the memory 14. FIG. 8 is a flowchart showing an example of operation of the read parameter adjustment processing according to the present embodiment. The MPU 12 determines whether all adjustment methods in the rearrangement table have been completed. In the case where all rearrangement methods have been completed (Y in S31), the MPU 12 determines the read check to be a failure (S32), and this flow ends. In the case where all adjustment methods have not been completed (N in S31), the flow advances to the next step.

Then, the MPU 12 acquires a next adjustment method (next record) from the rearrangement table (S33). In the case where the acquired adjustment method is not the read parameter increase/decrease processing (N in S34), the flow advances to the next step, while in the case where the acquired adjustment method is the read parameter increase/decrease processing (Y in S34), the MPU 12 performs the read parameter increase/decrease processing (S35), and flow advances to the next step. In the next step, in the case where the adjustment method is not the read parameter automatic following processing (N in S36), the flow advances to the next step, while in the case where the adjustment method is the read parameter automatic following processing (Y in S36), the MPU 12 performs the read parameter automatic following processing (S37), and the flow advances to the next step.

Then, the MPU 12 sets the read parameter acquired from the adjustment method in the read channel 16 to perform the read check. In the case where the read check failures (N in S38), the flow returns to step S31, while in the case where the read check successes (Y in S38), the MPU 12 determines the read check to be a success (S39), and the flow ends.

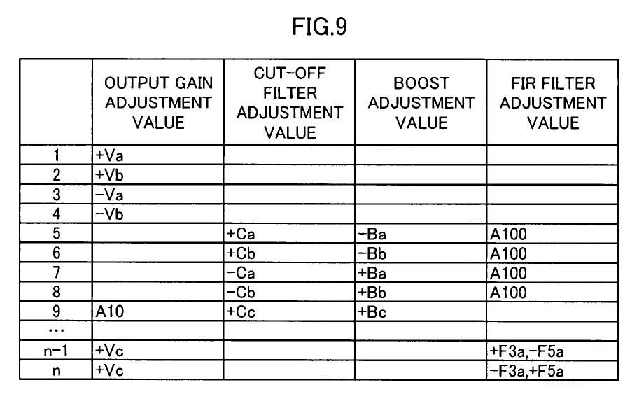

FIG. 9 is a table showing an example of the rearrangement table according to the present embodiment. In step S33, this table is read out record by record (row by row). Each record is one adjustment method to be performed. Respective records have record numbers (1 to n) assigned thereto, respectively, and each include an adjustment method with regard to the output gain adjustment value, cut-off filter adjustment value, boost adjustment value, and FIR filter coefficient. In this table, a vacant cell indicates that the relevant adjustment is not performed. In the case where the adjustment method is represented by a numerical value starting from “+” or “−”, the read parameter increase/decrease processing is performed. In this case, the numerical value indicates an increase/decrease amount. Although the increase/decrease amount is used in the table for a normal read retry operation, the range of the increase/decrease amount in the rearrangement table is larger than that in the table for the normal read retry operation. In the case where the adjustment method is represented by a numerical value starting from “A”, the read parameter automatic following processing is performed. In this case, the numerical value indicates the number of times of repetition of the read operation.

In the read parameter increase/decrease processing, the increase/decrease amount is added to the default value defined in the default table. The read parameter automatic following processing is performed for the error sector using the automatic following function of the read channel 16 by the set number of times of repetition (continuous reading) to thereby adjust the read parameter during the repetition of the read retry operation. It takes much time to complete such continuous reading, so that it has been difficult to perform the continuous reading in the normal read retry operation.

Although the adjustment methods are acquired in the order of the record number in the rearrangement table in the present embodiment, a configuration may be adopted in which the Quality Monitor value obtained by the reading operation after the adjustment of each record is previously stored for each record and the adjustment method are acquired in the ascending order of the Quality Monitor value.

According to the present embodiment, it is possible to collectively adjust a plurality of read parameters, thereby completing the adjustment more effective manner than the case where the read parameter is adjusted one by one. Further, by combining the read parameter increase/decrease processing for one read parameter and read parameter automatic following processing for another read parameter, more effective adjustment can be achieved.

### Third Embodiment

A magnetic disk drive according to a third embodiment performs read parameter adjustment processing that performs adjustment for each type of the read parameters.

The magnetic disk drive according to the present embodiment has the same configuration as that of the magnetic disk drive according to the first embodiment.

Further, the unrecoverable error processing performed in the present embodiment is the same as that of the first embodiment.

The read parameter adjustment processing according to the present embodiment will next be described.

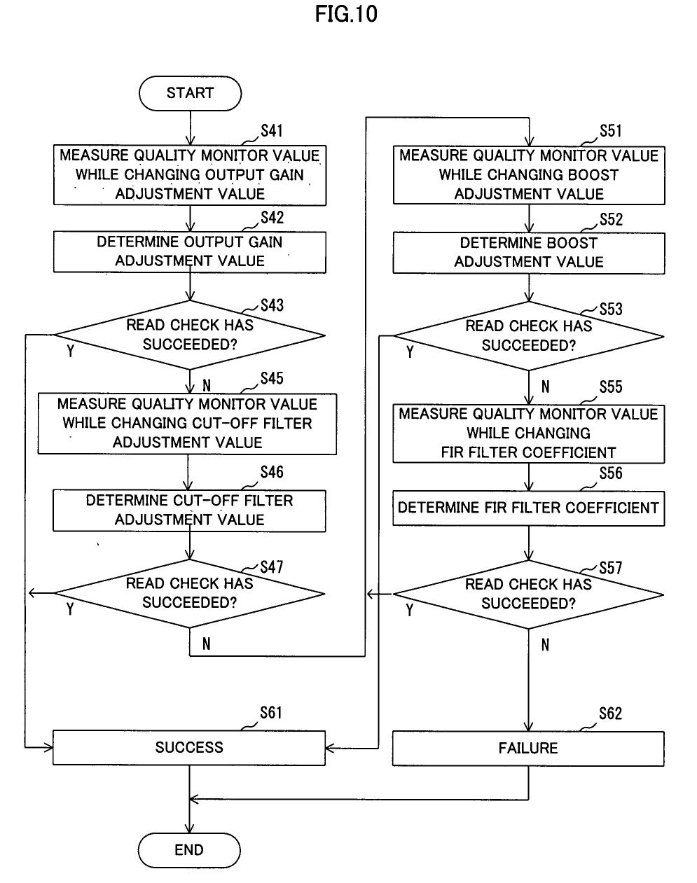

FIG. 10 is a flowchart showing an example of operation of the read parameter adjustment processing according to the present invention. The MPU 12 measures the Quality Monitor value while changing the output gain adjustment amount throughout the entire range (S41), determines the output gain adjustment amount at which the Quality Monitor value becomes minimum, and sets the determined output gain adjustment amount in the read channel 16 (S42). Then, the MPU 12 performs read check for the error sector. In the case where the reading operation has succeeded (Y in S43), the MPU 12 determines the read check to be a success (S61), and this flow ends. In the case where the reading operation has failed (N in S43), the flow advances to the next step.

Then, the MPU 12 measures the Quality Monitor value while changing the cut-off filter adjustment amount throughout the entire range (S45), determines the cut-off filter adjustment amount at which the Quality Monitor value becomes minimum, and sets the determined cut-off filter adjustment amount in the read channel 16 (S46). Then, the MPU 12 performs read check for the error sector. In the case where the reading operation has succeeded (Y in S47), the MPU 12 determines the read check to be a success (S61), and this flow ends. In the case where the reading operation has failed (N in S47), the flow advances to the next step.

Then, the MPU 12 measures the Quality Monitor value while changing the boost adjustment amount throughout the entire range (S51), determines the boost adjustment amount at which the Quality Monitor value becomes minimum, and sets the determined boost adjustment amount in the read channel 16 (S52). Then, the MPU 12 performs error check for the error sector. In the case where the reading operation has succeeded (Y in S53), the MPU 12 determines the read check to be a success (S61), and this flow ends. In the case where the reading operation has failed (N in S53), the flow advances to the next step.

Then, the MPU 12 measures the Quality Monitor value while changing the FIR filter coefficient throughout the entire range (S55), determines the FIR filter coefficient at which the Quality Monitor value becomes minimum, and sets the determined FIR filter coefficient in the read channel 16 (S56). Then, the MPU 12 performs read check for the error sector. In the case where the reading operation has succeeded (Y in S57), the MPU 12 determines the read check to be a success (S61), and this flow ends. In the case where the reading operation has failed (N in S57), the MPU 12 determines the read check to be a failure (S62), and this flow ends.

According to the present embodiment, individual read parameters can sequentially be adjusted in accordance with a state of the error sector.

An instruction acquisition section corresponds to the host interface 20 in the embodiments. An adjustment section and a reassignment section correspond to the MPU 12 in the embodiments. A read section corresponds to the read channel 16 in the embodiments.

The control of the magnetic disk drive according to the embodiments of the present invention can easily applied to a storage apparatus to thereby increase the performance thereof. Examples of the storage apparatus include, e.g., an optical disk drive, a magneto-optical disk drive, and the like.

What is claimed is:

1. A storage apparatus connectable to an external device, comprising:
an instruction acquisition section that notifies the external device that data cannot be read out in the case where there is an error sector from which data cannot be read out by a read retry operation and acquires an instruction from the external device;
an adjustment section that performs adjustment of a read parameter which is a parameter for data reading when the instruction acquisition section acquires the error sector recovery instruction from the external device; and
a read section that uses a parameter that has been adjusted by the adjustment section to read out data from the error sector.

2. The storage apparatus according to claim 1, further comprising a reassignment section that performs reassignment of sectors between error and normal sectors in the case where the read section has succeeded in reading out data from the error sector.

3. The storage apparatus according to claim 2, wherein
the reassignment section is further configured to write the data read out from the error sector in the reassigned sector.

4. The storage apparatus according to claim 1, wherein
the adjustment section performs adjustment of the read parameter throughout a range larger than that of the value of the read parameter adjusted by the read retry operation.

5. The storage apparatus according to claim 1, wherein
the adjustment section sets the read parameter in the read section while changing the read parameter to allow the read section to read out data from the error sector as well as uses a Quality Monitor function of the read section to measure a Quality Monitor value to adjust the read parameter so that the Quality Monitor value satisfies a predetermined Quality Monitor value condition.

6. The storage apparatus according to claim 5, wherein
the predetermined Quality Monitor value condition is a condition in which the Quality Monitor value becomes minimum.

7. The storage apparatus according to claim 1, wherein
the adjustment section allows the read section to read out data from the error sector at a plurality of times as well as uses an automatic following function of the read section to adjust the read parameter.

8. The storage apparatus according to claim 1, wherein
the adjustment section acquires information concerning a combination of a plurality of previously set adjustment methods of read parameters and adjusts the read parameters according to the information.

9. The storage apparatus according to claim 8, wherein
the information concerning a combination of a plurality of adjustment methods of read parameters differs from a value for adjusting the read parameter used in the read retry operation.

10. The storage apparatus according to claim 1, wherein
the read parameter is at least one of an output gain adjustment value which is a value for adjusting the output gain of a waveform to be read out, a cut-off filter adjustment value which is a value for adjusting the cut-off filter for a waveform to be read out, a boost adjustment value which is a value for adjusting the boost for a waveform to be read out, and an FIR filter coefficient for a waveform to be read out.

11. The storage apparatus according to claim 1, wherein
in the case where a waveform read out from the error sector satisfies a predetermined waveform condition, the adjustment section selects a predetermined read parameter and adjusts the selected read parameter.

12. The storage apparatus according to claim 11, wherein
the predetermined waveform condition is a condition in which the output level of a waveform read out from the error sector becomes lower than a predetermined value, and
the predetermined read parameter is the output gain adjustment value.

13. The storage apparatus according to claim 11, wherein
the predetermined waveform condition is a condition in which a waveform read out from the error sector includes a distortion component or bit-crushing, and
the predetermined read parameter is at least one of the cut-off filter adjustment value, boost adjustment value, and FIR filter coefficient.

14. A control apparatus for controlling a storage apparatus connectable to an external device, comprising:
an instruction acquisition section that notifies the external device that data cannot be read out in the case where there is an error sector from which data cannot be read out by a read retry operation and acquires an instruction from the external device;
an adjustment section that performs adjustment of a read parameter which is a parameter for data reading when the instruction acquisition section acquires the error sector recovery instruction from the external device; and
a read section that uses a parameter that has been adjusted by the adjustment section to read out data from the error sector.

15. The control apparatus according to claim 14, further comprising a reassignment section that performs reassignment of sectors between error and normal sectors in the case where the read section has succeeded in reading out data from the error sector.

16. The control apparatus according to claim 15, wherein
the reassignment section is further configured to write the data read out from the error sector in the reassigned sector.

17. The control apparatus according to claim 14, wherein
the adjustment section performs adjustment of the read parameter throughout a range larger than that of the value of the read parameter adjusted by the read retry operation.

18. The control apparatus according to claim 14, wherein
the adjustment section changes the read parameter to read out data from the error sector as well as uses a Quality Monitor function to measure a Quality Monitor value to adjust the read parameter so that the Quality Monitor value satisfies a predetermined Quality Monitor value condition.

19. The control apparatus according to claim 18, wherein
the predetermined Quality Monitor value condition is a condition in which the Quality monitor value becomes minimum.

20. The control apparatus according to claim 14, wherein
the adjustment section reads out data from the error sector at a plurality of times as well as uses an automatic following function to adjust the read parameter.
